(19) United States
(12) Patent Application Publication
(10) Pub. No.: US 2011/0304955 A1
(43) Pub. Date: Dec. 15, 2011

(54) Fabrication of electrochemical capacitors based on inkjet printing

(75) Inventors: Chongwu Zhou, Arcadia, CA (US); Po-Chiang Chen, Hillsboro, OR (US); Jing Qiu, Los Angeles, CA (US); Haitian Chen, Los Angeles, CA (US)

(73) Assignee: UNIVERSITY OF SOUTHERN CALIFORNIA, Los Angeles, CA (US)

(21) Appl. No.: 13/099,248

(22) Filed: May 2, 2011

Related U.S. Application Data
(60) Provisional application No. 61/329,910, filed on Apr. 30, 2010.

(51) Int. Cl. H01G 5/38; A41D 1/00; H01G 9/025; H01G 13/00; B82Y 99/00

(52) U.S. Cl. 361/541; 361/523; 361/434; 156/182; 2/69; 977/948; 977/762; 977/788

(57) ABSTRACT

An electrochemical capacitor includes a first electrode including a first flexible substrate, a second electrode including a second flexible substrate, and an electrolyte. The first electrode includes a first layer of single-walled carbon nanotubes inkjetted on the first flexible substrate and a layer of first nanowires disposed on the first layer of single-walled carbon nanotubes. The second electrode includes a second layer of single-walled carbon nanotubes inkjetted on the second flexible substrate and a layer of second nanowires disposed on the second layer of single-walled carbon nanotubes. The electrolyte is sandwiched between the layer of first nanowires and the layer of second nanowires to form the electrochemical capacitor. A flexible energy storage device includes a first flexible substrate, a second flexible substrate, and one or more electrochemical capacitors formed between the first flexible substrate and the second flexible substrate. The flexible energy storage device can be wearable.

### CROSS-REFERENCE TO RELATED APPLICATION

This application claims priority to U.S. Application Ser. No. 61/329,910, filed on Apr. 30, 2010, which is incorporated herein by reference.

### FEDERALLY SPONSORED RESEARCH OR DEVELOPMENT

The invention was made with government support under Computing and Communications Foundation Grant Nos. CCF 0726815 and CCF 0702204 awarded by the National Science Foundation. The government has certain rights in the invention.

### TECHNICAL FIELD

This invention relates to electrochemical capacitors and uses thereof.

### BACKGROUND

Electrochemical capacitors, or supercapacitors, include electrical double-layer capacitors (EDLCs) and redox supercapacitors. Carbonaceous materials, such as activated carbons, carbon fibers, aerogels, and nanostructured carbon materials, have been used in the fabrication of EDLCs.

### SUMMARY

Wearable energy conversion and storage devices such as supercapacitors can be fabricated on flexible substrates using an inkjet printer. In some cases, printable storage devices appear optically transparent. The inkjet printing method provides a non-contact deposition method for obtaining single-walled carbon nanotube (SWNT) films and allows selection of pattern geometry, size, location, electrical conductivity, film thickness, and uniformity. The printed supercapacitors can be fully integrated with the fabrication process of printed electronics.

In a first aspect, fabricating an electrochemical capacitor includes inkjetting a first composition including single-walled carbon nanotubes on selected portions of a first flexible substrate to form a first layer of single-walled carbon nanotubes on the selected portions of the first flexible substrate. First nanowires are disposed on the first layer of single-walled carbon nanotubes to form a layer of first nanowires on the first layer of single-walled carbon nanotubes, thereby forming a first electrode. A second composition including single-walled carbon nanotubes is inkjetted on selected portions of a second flexible substrate to form a second layer of single-walled carbon nanotubes on the selected portions of the second flexible substrate. Second nanowires are disposed on the second layer of single-walled carbon nanotubes to form a layer of second nanowires on the second layer of single-walled carbon nanotubes, thereby forming a second electrode. An electrolyte is disposed on a first one of the nanowire layers, and a second one of the nanowire layers is contacted with the electrolyte to adhere the first electrode to the second electrode, thereby forming an electrochemical capacitor between the first flexible substrate and the second flexible substrate.

In another aspect according to the first aspect, contacting the second one of the nanowire layers with the electrolyte to adhere the first electrode to the second electrode includes aligning the selected portions of the first flexible substrate and the selected portions of the second flexible substrate, thereby forming a multiplicity of electrochemical capacitors between the first flexible substrate and the second flexible substrate.

In another aspect according to the first aspect, the first composition and the second composition are different.

In another aspect according to the first aspect, the first nanowires and the second nanowires are different.

In another aspect according to the first aspect, disposing the first nanowires on the first layer of single-walled carbon nanotubes includes disposing metal oxide nanowires on the first layer of single-walled carbon nanotubes.

In another aspect according to the first aspect, disposing the first nanowires on the first layer of single-walled carbon nanotubes includes disposing ruthenium oxide nanowires on the first layer of single-walled carbon nanotubes.

In another aspect according to the first aspect, disposing the second nanowires on the second layer of single-walled carbon nanotubes includes disposing metal oxide nanowires on the second layer of single-walled carbon nanotubes.

In another aspect according to the first aspect, disposing the second nanowires on the second layer of single-walled carbon nanotubes includes disposing ruthenium oxide nanowires on the second layer of single-walled carbon nanotubes.

In another aspect according to the first aspect, disposing the electrolyte on the first one of the nanowire layers includes disposing a dry polymer thin film electrolyte on the first one of the nanowire layers.

In a second aspect, an electrochemical capacitor includes a first electrode including a first flexible substrate, a second electrode including a second flexible substrate, and an electrolyte. The first electrode includes a first layer of single-walled carbon nanotubes inkjetted on the first flexible substrate and a layer of first nanowires disposed on the first layer of single-walled carbon nanotubes. The second electrode includes a second layer of single-walled carbon nanotubes inkjetted on the second flexible substrate and a layer of second nanowires disposed on the second layer of single-walled carbon nanotubes. The electrolyte is sandwiched between the layer of first nanowires and the layer of second nanowires to form the electrochemical capacitor.

In another aspect according to the second aspect, the first nanowires include metal oxide nanowires.

In another aspect according to the second aspect, the first nanowires include ruthenium oxide nanowires.

In another aspect according to the second aspect, the second nanowires include metal oxide nanowires.

In another aspect according to the second aspect, the second nanowires include ruthenium oxide nanowires.

In another aspect according to the second aspect, the electrolyte is a dry polymer thin film electrolyte.

In another aspect according to the second aspect, the electrolyte inhibits transfer of electrons between the first electrode and the second electrode.

In another aspect according to the second aspect, the first flexible substrate and the second flexible substrate include fabric.

In a third aspect, a flexible energy storage device includes a first flexible substrate, a second flexible substrate, and one or more electrochemical capacitors formed between the first flexible substrate and the second flexible substrate.

In another aspect according to the third aspect, at least one of the electrochemical capacitors includes a first electrode, a second electrode, and an electrolyte. The first electrode includes a first flexible substrate, a first layer of single-walled carbon nanotubes inkjetted on the first flexible substrate, and a layer of first nanowires disposed on the first layer of single-walled carbon nanotubes. The second electrode includes a second flexible substrate; a second layer of single-walled carbon nanotubes inkjetted on the second flexible substrate, and a layer of second nanowires disposed on the second layer of single-walled carbon nanotubes. The electrolyte is sandwiched between the layer of first nanowires and the layer of second nanowires.

In another aspect according to the third aspect, the flexible energy storage device includes comprising a light-emitting device electrically connected to at least one of the electrochemical capacitors.

In another aspect according to the third aspect, the flexible energy storage device is an article of clothing.

These general and specific aspects may be implemented using a device, system or method, or any combination of devices, systems, or methods. The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1A depicts an electrochemical capacitor on a flexible substrate. FIG. 1B depicts an electrochemical capacitor on an article of clothing.

FIG. 2 depicts an electrochemical capacitor.

FIG. 3 is a flowchart showing a process of forming a flexible electrochemical capacitor on a flexible substrate.

FIGS. 4A-4C show scanning electron microscope (SEM) images of multiple prints of functionalized single-walled carbon nanotubes inkjet-printed on a piece of fabric. FIG. 4D shows an electrolyte sandwiched between electrodes of an electrochemical capacitor.

FIG. 5 is a SEM image of inkjet-printed SWNT films on a polyethylene terephthalate (PET) substrate.

FIG. 6 shows conductance and transmittance of the printed SWNT patterns on PET substrates as a function of printed thickness.

FIG. 7 shows cyclic voltammograms of an inkjet-printed SWNT supercapacitor on a PET substrate at different scan rates.

FIG. 8 shows cyclic voltammograms of an inkjet-printed SWNT supercapacitor on cloth fabric at different scan rates.

FIG. 9 shows galvanostatic charge/discharge curves for a thin film SWNT/PET supercapacitor.

FIG. 10 shows galvanostatic charge/discharge curves for a thin film SWNT/cloth fabric supercapacitor.

FIG. 11 shows an electrochemical impedance spectrum at 0.1 V bias voltage on a supercapacitor built from a SWNT/PET substrate.

FIG. 12 shows equivalent series resistance (ESR) and power density of SWNT/PET supercapacitors as a function of printed thickness.

FIG. 13 shows acyclic life of a SWNT/PET supercapacitor during a charge/discharge cycle.

FIG. 14 shows a SEM image of RuO₂ nanowires dispersed on an inkjet-printed SWNT film (×200 prints).

FIG. 15 shows cyclic voltammograms a of RuO₂ nanowire/inkjet-printed SWNT supercapacitor on a PET substrate at different scan rates.

FIG. 16 shows galvanostatic charge/discharge curves a RuO₂ nanowire/inkjet-printed SWNT supercapacitor.

FIG. 17 shows an electrochemical impedance spectrum at 0.1 V bias voltage on a SWNT/PET supercapacitor and an RuO₂ nanowire/inkjet-printed SWNT supercapacitor.

### DETAILED DESCRIPTION

As described herein, nanowire/single-walled carbon nanotube (SWNT) thin film electrodes are inkjet-printed on flexible substrates including plastics and textiles, allowing selection of pattern geometry (e.g., feature sizes ranging from 0.4 cm² to 6 cm²), location, thickness (e.g., ranging from 20 nm to 200 nm), and electrical conductivity. Compared to SWNT thin film electrodes without the nanowires, the nanowire/SWNT electrodes are shown to increase knee frequency, specific capacitance, power density, and energy density. Good capacitive behavior is demonstrated even after 1,000 charging/discharging cycles. This combination of features provides improvements in printable and wearable energy storage devices.

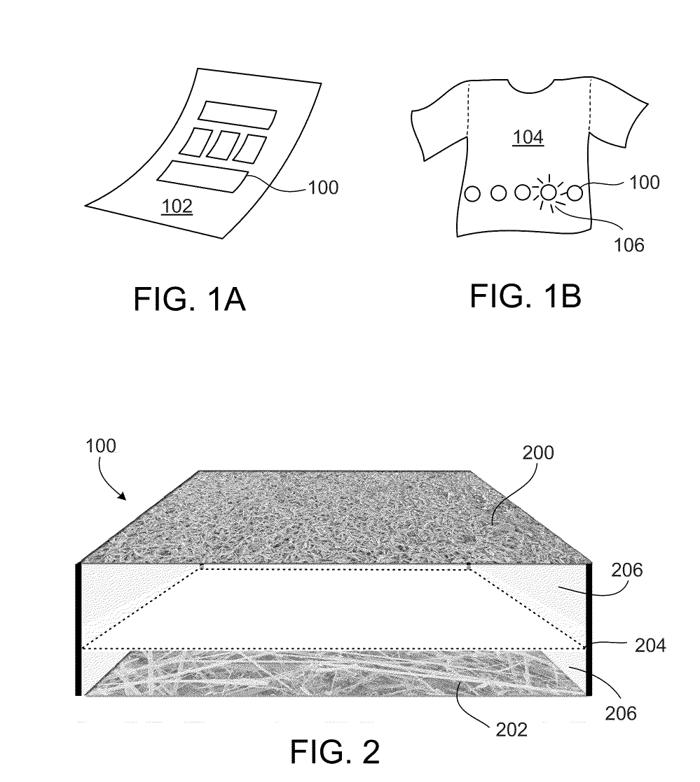

FIG. 1A shows electrochemical capacitor 100 printed on flexible substrate 102. Flexible substrate 102 can be a plastic, a natural or synthetic fabric, a woven or nonwoven fabric, or the like. As shown in FIG. 1B, flexible substrate 102 may be a wearable energy storage devices, for example, in the form of clothing article 104. Electrochemical capacitor 100 may function, for example, to power light emitting device 106 on clothing article 104.

Referring to FIG. 2, electrochemical capacitor 100 includes flexible anode 200, flexible cathode 202, separator 204, and electrolyte 206. Separator 204 provides electrical insulation between electrodes 200 and 202 while allowing ions to move from one electrode to the other. Materials suitable for use as separator 204 include, for example nitrocellulose and NAFION. Suitable electrolytes include polymer or gel electrolytes such as, for example, ionic liquids including lithium and potassium ion salts such as LiClO₄ and LiPF₆ in ethylene carbonate/diethyl carbonate (EC/DEC), poly(vinyl alcohol)/phosphoric acid (PVA/H₃PO₄), and the like. Electrolyte 206 can also function as a separator, in which case separator 204 may be absent. When electrolyte 206 functions as a separator, electrochemical capacitor 100 includes anode 200, cathode 202, and electrolyte 206. Electrolyte 206 may be in the form of a dry polymer thin film electrolyte.

Anode 200 and cathode 202 include hybrid nanowire/SWNT films, where the nanowires include metal oxide nanowires. In an example, the metal oxide nanowires are transition metal oxide nanowires. Anode 200 and cathode 202 can be the same or different. For example, anode 200 and cathode 202 can include metal oxide nanowires made of the same metal oxide or different metal oxides. The nanostructured films function as current collecting electrodes. As such, electrochemical capacitor 100 can operate in the absence of metal current collecting electrodes. The SWNTs in the metal oxide/SWNT hybrid films contribute to electrical double-layer capacitance, and the metal oxide nanowires contribute to the high energy density and high power density of electrochemical capacitor 100. Thus, charge can be stored via electrochemical double-layer capacitance as well as through reversible Faradaic processes.

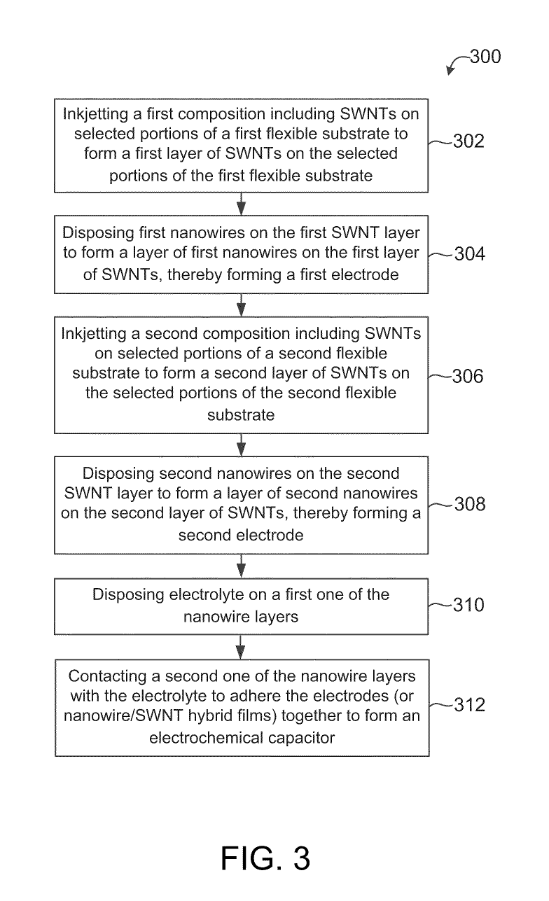

FIG. 3 shows a flow chart showing process 300 to fabricate an electrochemical capacitor between flexible substrates. A first composition including SWNTs is inkjetted 302 on selected portions of a first flexible substrate to form a first layer of SWNTs on the selected portions of the first substrate. First nanowires are disposed 304 on the first SWNT layer to form a layer of first nanowires on the first layer of SWNTs, thereby forming a first electrode. Suitable nanowires include metal oxide nanowires. In an example, the metal oxide nanowires include transition metal oxide nanowires. In an example, a suspension of nanowires is prepared, and the suspension is disposed on the SWNT layer and then dried.

A second composition including SWNTs is inkjetted 306 on selected portions of a second flexible substrate to form a second layer of SWNTs on the selected portions of the second substrate. The first flexible substrate and the second flexible substrate can differ, for example, in composition, thickness, or other chemical or physical properties. The first composition including SWNTs and the second composition including SWNTs can be the same or different. Second nanowires are disposed 308 on the second layer of SWNTs to form a layer of second nanowires on the second layer of SWNTs, thereby forming a second electrode. The first nanowires and the second nanowires can be the same or different.

Electrolyte is disposed 310 on a first one of the nanowire layers. In an example, the electrolyte is a gel electrolyte in the form of a dry polymer thin film electrolyte. A second one of the nanowire layers is contacted 312 with the electrolyte to adhere the electrodes (or nanowire/SWNT hybrid films) together to form an electrochemical capacitor between the first flexible substrate and the second flexible substrate. Contacting the second one of the nanowire layers with the electrolyte to adhere the first electrode to the second electrode can include aligning the selected portions of the first flexible substrate and the selected portions of the second flexible substrate, thereby forming a multiplicity of electrochemical capacitors between the first flexible substrate and the second flexible substrate.

Aspects of fabrication and testing of inkjet-printed SWNT electrodes, nanowire/inkjet-printed SWNT hybrid film electrodes, and electrochemical capacitors including inkjet-printed SWNT electrodes and nanowire/inkjet-printed SWNT hybrid film electrodes are described below to allow comparison between inkjet-printed SWNT electrodes and capacitors and nanowire/inkjet-printed SWNT hybrid film electrodes and capacitors

In one example, arc-discharge nanotubes (P3 nanotubes from Carbon Solutions Inc.) were mixed with 1 wt % aqueous sodium dodecyl sulfate (SDS) in deionized (D.I.) water to make a dense SWNT suspension with a concentration of about 0.2 mg/mL. The addition of SDS surfactant improves the solubility of SWNTs (e.g., by sidewall functionalization). The SWNT solution was then ultrasonically agitated using a probe sonicator for about 20 minutes with an intensity of 200 Watts, followed by centrifugation to separate out undissolved SWNT bundles and impurities. SWNTs of moderate length (e.g., about 500 nm to about 1.5 μm) were used to reduce flocculation of the SWNTs in solution and thus reduce nozzle clogging during printing.

The SDS-functionalized SWNT inks were loaded into cleaned Epson T078120 (black) ink cartridges with a syringe and allowed to equilibrate for several minutes before printing with an Epson piezoelectric printer (Artisan 50, resolution 1,440×1,440 dots per inch (dpi)). Patterns were printed onto transparent polyethylene terephthalate (PET) sheets, cloth fabrics, and SiO₂/Si substrates. The printed film thickness was determined from topographical analysis of the films using an atomic force microscope (AFM) (Digital Instruments, Dimension 3100). The mass of the SWNTs deposited on each substrate was determined by weighing the substrates before and after printing.

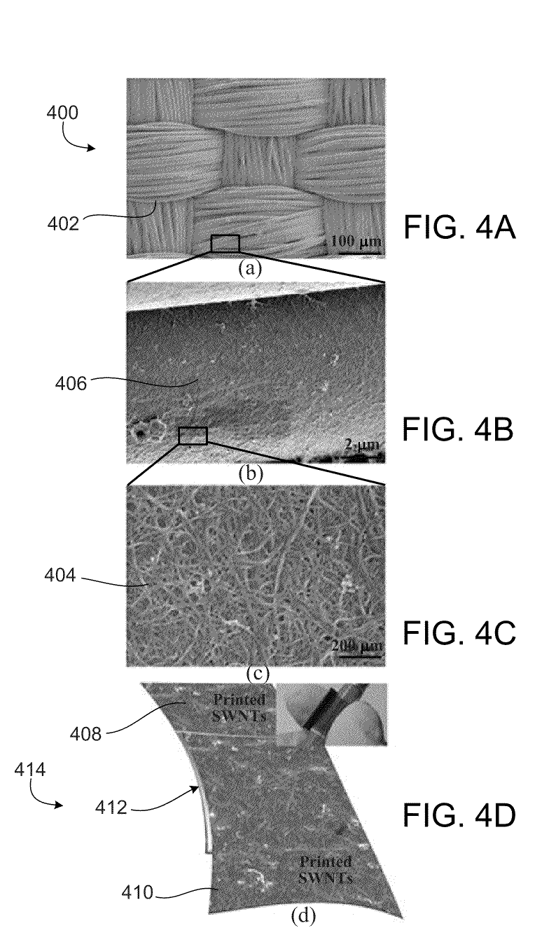

FIG. 4A shows an SEM image of woven fabric 400 with fibers 402. An inkjet ink composition including SWNTs 404 was printed (200 times) to form a layer of SWNTs 406 on fabric 400. As the dispensed ink dried, a tangled, dense network was formed on the surface of fibers 402, yielding thin film electrode 408. SWNT bundle lengths ranged from about 0.2 μm to about 1.8 μm, and SWNT diameters ranged from about 9 nm to about 20 nm. A second thin film electrode 410 was prepared.

The gel electrolyte was prepared by mixing poly(vinyl alcohol) (PVA) powder with water (1 g of PVA/10 mL of D.I. water) and 2 mL phosphoric acid (H₃PO₄). Excess water in a vacuum oven at 60° C. to form a dry polymer thin film electrolyte 412. Thin film electrodes 408 and 410 were sandwiched together with dry polymer thin film electrolyte 412 to form electrochemical capacitor 414 shown in FIG. 4D. The solid PVA/H₃PO₄ electrolyte functioned as both the separator between two SWNT electrodes and the electrolyte for ion transportation.

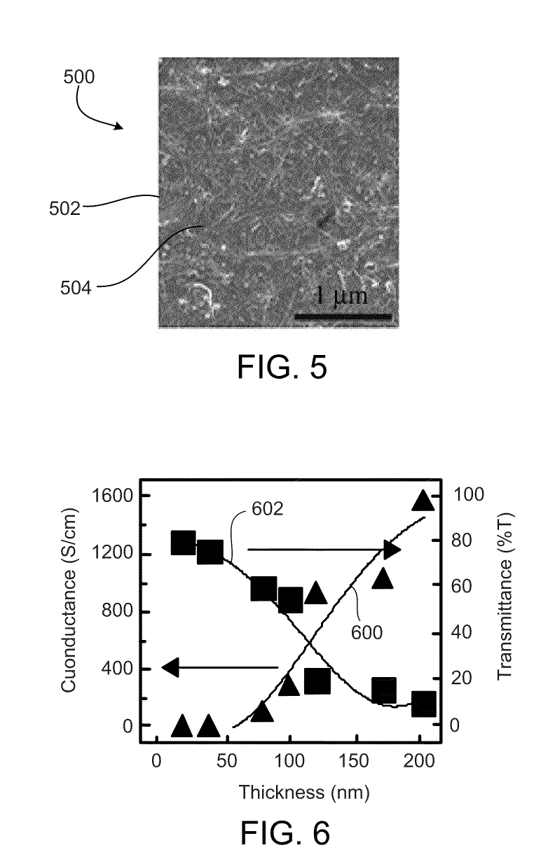

In another example, SWNTs were printed on a flexible, 4 inch² PET sheet with various pattern geometries. The printed portions had different surface areas (e.g., ranging from about 0.4 cm² to about 6 cm²) and locations. Electrically conductive SWNT patterns including 40, 80, 120, and 200 prints were formed. The optical transmittance was measured to be about 80% in the visible light region (400 nm to 700 nm, with a minimum of 20 repetitions on PET substrates). As seen in FIG. 5, electrode 500 includes PET substrate 502, and tangled and randomly oriented networks of SWNTS 504. These printed PET substrates can also be used in the fabrication of electrochemical capacitors without additional treatment.

To assess the electrical conductivity and the optical transparency of printed SWNT films, four-probe direct current (DC) measurements and transmittance measurements were performed on inkjet-printed SWNT films with different film thickness. The printed SWNT films on PET substrate (SWNT/PET) used for the fabrication of supercapacitors were typically printed for a number of 200 times, and had a sheet resistance of about 78Ω/□ with a thickness of 0.2 μm and an optical transparency of about 10%. For SWNT films printed on cloth fabric (SWNT/fabric) with similar print numbers (×200 prints), the sheet resistance was typically about 815 Ω/□.

With each successive inkjet printing, the nanotube film thickness (t) increased. As seen in FIG. 6, for a PET substrate, conductivity (plot 600) increased from 0.54 S/cm (t=20 nm) to 1,562 S/cm (t=200 nm). The improved conductivity can be attributed at least in part to the better percolation of the deposited SWNTs, which improves the number of electrical pathways. However, the increased printed thickness resulted in more light being absorbed, thereby reducing the optical transparency (plot 602) from 80% (t=20 nm) to 12% (t=200 nm) in the visible light region. The sheet resistance (Rₛ) of the inkjet-printed SWNT films was about 78Ω/□ for a thickness of 0.2 μm.

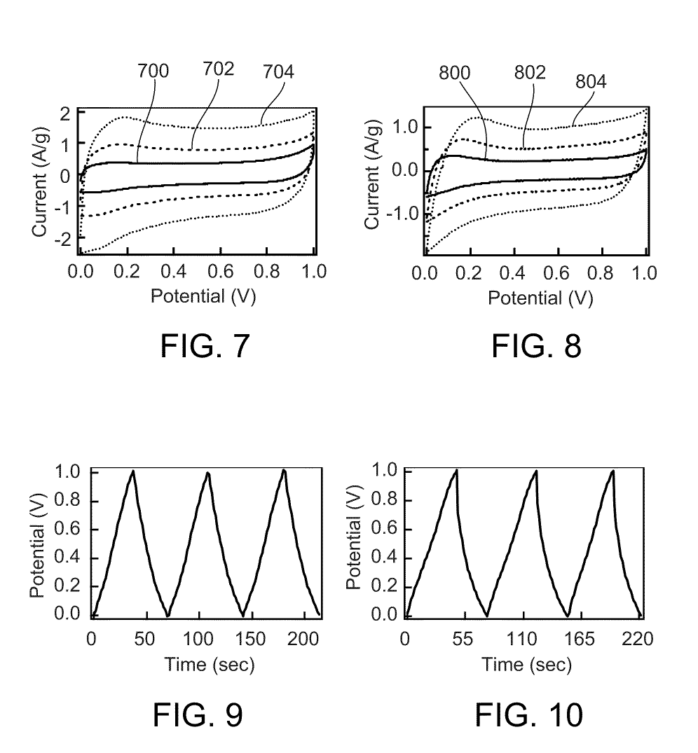

Cyclic voltammetry (CV) measurements were carried out (0 V to 1 V) to evaluate the stability of electrochemical cells formed by sandwiching two inkjet-printed SWNT film electrodes together with a gel polymer electrolyte. Galvanostatic (GV) charge/discharge measurements (0 V to 1 V) were used to evaluate the specific capacitance (Cₛₚ), power density, and the internal resistance (IR) of the devices in a two-electrode configuration. FIG. 7 shows the CV curves of a SWNT/PET supercapacitor, with scan rates of 20 mV/sec (plot 700), 50 mV/sec (plot 702), and 100 mV/sec (plot 704). The supercapacitor showed good electrochemical stability and capacitive behavior for printed SWNT thin film electrodes with a gel polymer electrolyte. The quasi-rectangular shape of these curves near 0.2 V can be attributed at least in part to the presence of carboxylic acid groups (—COON, with 3-6% of the SWNT surface covered by carboxylic acid groups) attached on the sidewall of the SWNTs and the resulting pseudocapacitance. The pseudocapacitive behavior was further confirmed by the impedance measurements discussed below.

For SWNT/fabric supercapacitors, the CV curves shown in FIG. 8, with scan rates of 20 mV/sec (plot 800), 50 mV/sec (plot 802), and 100 mV/sec (plot 804) were also regular and of rectangular shape, similar to SWNT/PET supercapacitors, but with a smaller current density due at least in part to the higher sheet resistance of the SWNT films printed on cloth fabric. The fibrous nature of the fabric and reduced percolation of the SWNT coating can be factors in the increased sheet resistance of SWNT/fabric supercapacitor.

FIG. 9 shows GV charging/discharging behavior of a SWNT/PET supercapacitor, with a charging/discharging current density of 1 mA/mg. The charging/discharging curves show good capacitive behavior, with an IR drop of about 0.05 V. FIG. 10 shows GV charging/discharging behavior of a SWNT/fabric supercapacitor, with a charging/discharging current density of 1 mA/mg. The GV charging/discharging behavior of a SWNT/fabric supercapacitor also shows good capacitive behavior, with a larger IR drop of about 0.22 V. The larger IR drop compared to that of the SWNT/PET supercapacitor can be attributed to the high sheet resistance of SWNT films printed on cloth fabric.

The specific capacitance (Cₛₚ) was calculated from the charge/discharge curves, according to the following equation:

$${C}_{sp} = ( \frac{I}{- d V / d t} ) ( \frac{1}{{m}_{1}} + \frac{1}{{m}_{2}} ) , \qquad ( 1 )$$

in which I is the applied discharging current, m₁ and m₂ are the mass of each electrode, and dV/dt is the slope of the of discharge curve after voltage drop. The specific capacitance of SWNT/PET and SWNT/fabric supercapacitors is about 65 F/g and 60 F/g, respectively.

The power density (P) can be obtained using the following equation:

$$P = \frac{{V}^{2}}{4 RM} \qquad ( 2 )$$

in which V is the applied voltage, R is the equivalent series resistance (ESR), and M is the total mass of the printed SWNT film electrode. The measured power density of SWNT/PET and SWNT/fabric supercapacitors is about 4.5 kW/kg and 3.0 kW/kg, respectively. The specific energy density (Eₛₚ) of the devices was calculated using Eₛₚ=0.5 CₛₚV². The calculated specific energy density is about 8.2 Wh/kg and 6.1 Wh/kg for SWNT/PET and SWNT/fabric supercapacitors, respectively.

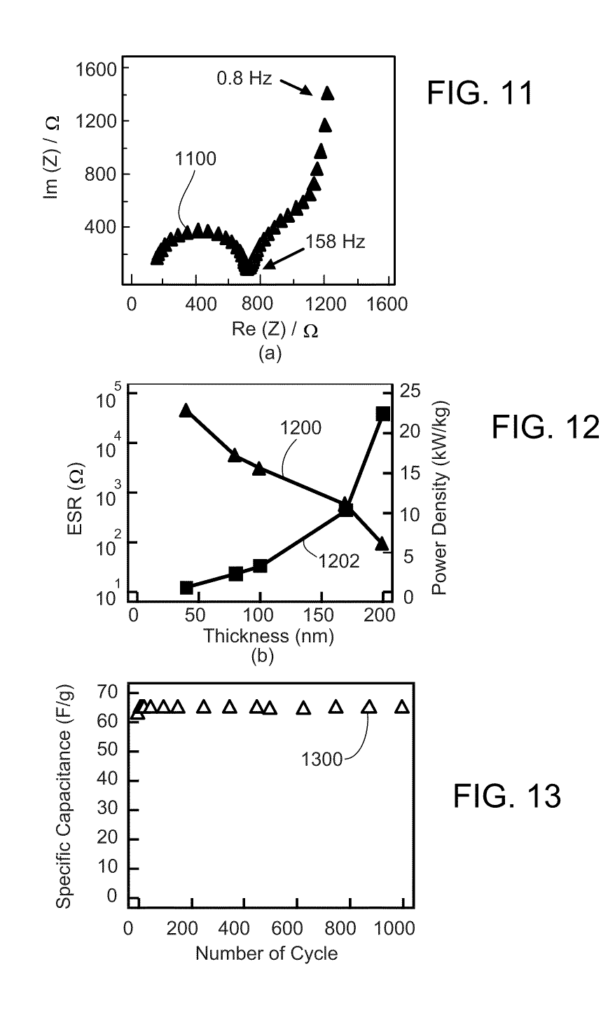

To determine the frequency response and the ESR of inkjet-printed SWNT thin film electrodes, electrochemical impedance spectroscopy (EIS) measurements were performed. The measurements were carried at a direct current (DC) bias voltage of 0 V, with a 10 mV amplitude sinusoidal signal, using a Gamry Reference 600 potentiostat/galvanostat in 1 M Na₂SO₄ electrolyte. The Nyquist plot of the multiple printed SWNT film electrodes (×200) is shown in FIG. 11. The imaginary part of impedance increases at lower frequency, indicating the capacitive behavior of printed SWNT films. The presence of semicircle 1100 arises from the double-layer capacitance coupled with a Faradaic reaction resistance and a series resistance of the solution in contact with printed SWNT films, which suggests the presence of the redox reaction:

>C−OH [symbol] >C=O+H⁺+e⁻

>C=O+e⁻ [symbol] >C=O⁻. (3)

The impedance curve appears to intersect the real axis (Re (Z)) at a 45° angle, which is consistent with the porous nature of the electrode when saturated with electrolyte. The knee frequency of the printed SWNT films is about 158 Hz, which suggests that most of its stored energy is accessible at frequency below 158 Hz.

To investigate the relationship of the ERS and power density of printed SWNT thin film electrodes, EIS measurements were performed on samples with different thickness (40 nm, 80 nm, 0.1 μm, 0.17 μm, and 0.2 μm) of printed SWNT films in 1 M Na₂SO₄ electrolyte. In some cases, the ESR of printed SWNT thin film electrodes can be extracted from the high frequency part of EIS curves. For instance, FIG. 12 shows that the ESR of a 0.2 μm SWNT films is about 90.7Ω (plot 1200). The ESR decreases with increasing film thickness, whereas the power density (plot 1202) increases and appears to saturate at a thickness of 0.2 μm. A 0.2 μm SWNT film shows a power density of 22.3 kW/kg.

To evaluate the stability of printed SWNT thin film supercapacitors, charging/discharging measurements were carried out with printed SWNT/PET supercapacitors in polymer electrolyte. The values of specific capacitance with respect to charging/discharging cycle number were measured (up to 1,000 cycles). FIG. 13 shows that the specific capacitance (plot 1300) of the SWNT/PET supercapacitor maintains good stability without noticeable decrease in capacitance after 1,000 cycles.

In another example, RuO₂ nanowires with diameters between about 100 nm and about 200 nm and lengths between about 5 μm and about 10 μm were prepared via a thermal CVD method. A 5 nm gold film was deposited on Si/SiO₂ substrate as a catalyst using an e-beam evaporator, followed by annealing at 700° C. for 30 minutes. The substrate was then placed into a quartz tube at the downstream end of a furnace, while stoichiometric RuO₂ powder (Sigma-Aldrich 99.999%, metal basis) utilized as the precursor was placed at the center of the furnace. During growth, the quartz tube was maintained at a pressure of 10 Torr and a temperature of 960° C., with a constant flow of 100 standard cubic centimeters (sccm) oxygen (99.99%). The reaction time was between 3-4 hours.

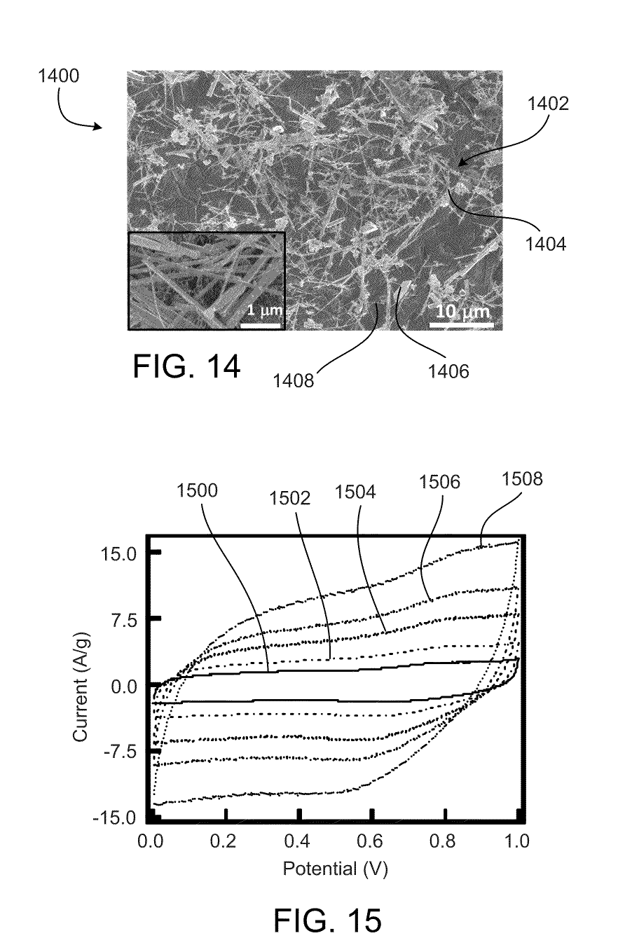

The resulting RuO₂ nanowires were sonicated into isopropanol alcohol (IPA) to form a nanowire suspension and then dispersed on printed SWNT films by dropping portions of the suspension on a PET substrate with a micro-pipette to form RuO₂ nanowire/SWNT hybrid films. The FIG. 14 is a SEM image showing RuO₂ nanowire/SWNT hybrid film 1400 with RuO₂ nanowire network 1402 and RuO₂ nanowires 1404. Some RuO₂ flakes 1406 from the nanowire synthesis can be seen on the film. SWNT film 1408 is visible underneath RuO₂ nanowires 1404. From the inset, it can be estimated that the density of RuO₂ nanowires 1404 dispersed on SWNT film 1408 is about 6 nanowires/μm.

In another example, two RuO₂ nanowire/SWNT hybrid films on PET substrates were sandwiched together with a PVA/H₃PO₄ polymer electrolyte to form an electrochemical cell. CV behavior of the hybrid supercapacitor is shown in FIG. 15, with different scan rates of 50 mV/sec (plot 1500), 100 mV/sec (plot 1502), 200 mV/sec (plot 1504), 300 mV/sec (plot 1506), and 500 mV/sec (plot 1508). The curves displayed a quasi-rectangular shape with a higher current density than printed SWNT film supercapacitors in FIGS. 7 and 8. This higher current density can be attributed at least in part to the low ESR of the hybrid RuO₂ nanowire/printed SWNT films. The shape of these CV curves is also different than that of the printed SWNT supercapacitors, which can be due to the pseudocapacitance contributed from RuO₂ nanowires through the following electrochemical protonation:

RuO₂+δH⁺+δe⁻→RuO_{2-δ}(OH)_{δ} (1≧δ≧0). (4)

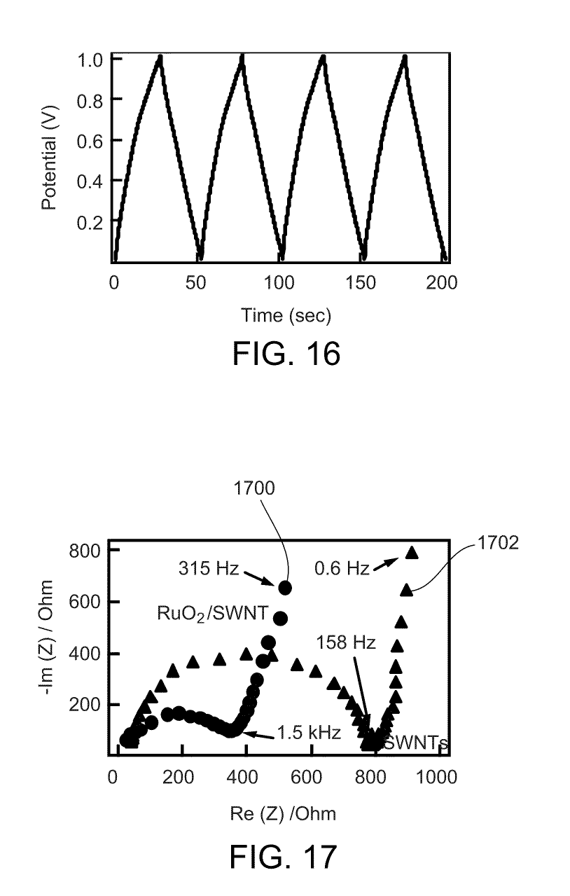

To evaluate the performance of supercapacitors including RuO₂ nanowire/SWNT films, GV charging/discharging experiments were performed with a charging/discharging current of 8 mA/mg. FIG. 16 shows a voltage drop of 0.02 V for the RuO₂ nanowire/SWNT film, with a specific capacitance of 135 F/g, a power density of 96 kW/kg, and an energy density of 18.8 Wh/kg. Thus, the combination of RuO₂ nanowires with the inkjetted SWNTs to form hybrid films yields improved performance of the resulting supercapacitors compared to the supercapacitors formed with SWNTs in the absence of RuO₂ nanowires. The combination of RuO₂ nanowires with the inkjetted SWNTs contribute to improved conductivity, intrinsic reversibility of surface redox reactions, and ultrahigh pseudocapacitance.

FIG. 17 illustrates the results of impedance spectroscopy on the bare SWNT films (plot 1700) and the RuO₂ nanowire/inkjet-printed SWNT films (plot 1702) in 0.3 M H₂SO₄ solution at a DC bias voltage of 0 V and with a 10 mV amplitude sinusoidal signal. Compared to that of the bare SWNT film electrodes, the Nyquist plot of the RuO₂ nanowire/inkjet-printed SWNT film electrodes shows that the imaginary part of impedance sharply increases at lower frequency, suggesting that the SWNT film retains its electron-transfer capability with the integration of RuO₂ nanowires. It can be seen that the diameter of semicircle in the Nyquist plot of the RuO₂ nanowire/SWNT hybrid film is smaller than that of the bare SWNT film, suggesting that the electrochemical reaction on the electrode/electrolyte interface of RuO₂ nanowire/SWNT hybrid films is more facile than the reaction on bare printed SWNT thin film electrodes.

Additionally, from the point intersecting with the real axis in the range of high frequency (10 kHz), the ESR of the RuO₂ nanowire/printed SWNT film electrode (21.86Ω) is lower than that of the bare SWNT film electrode (43Ω), suggesting that the integration of RuO₂ nanowires with SWNT film electrodes increases the conductivity of printed SWNT film electrodes. According to Equation 2, the RuO₂ nanowire/SWNT hybrid films are expected to possess higher power density and better rate behavior than SWNT thin film electrodes in H₂SO₄ electrolyte. The knee frequency of RuO₂ nanowire/inkjet-printed SWNT is about 1500 Hz, which is higher than the knee frequency of printed SWNT film electrodes (about 158 Hz).

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A method of fabricating an electrochemical capacitor, the method comprising:
inkjetting a first composition comprising single-walled carbon nanotubes on selected portions of a first flexible substrate to form a first layer of single-walled carbon nanotubes on the selected portions of the first flexible substrate;
disposing first nanowires on the first layer of single-walled carbon nanotubes to form a layer of first nanowires on the first layer of single-walled carbon nanotubes, thereby forming a first electrode;
inkjetting a second composition comprising single-walled carbon nanotubes on selected portions of a second flexible substrate to form a second layer of single-walled carbon nanotubes on the selected portions of the second flexible substrate;
disposing second nanowires on the second layer of single-walled carbon nanotubes to form a layer of second nanowires on the second layer of single-walled carbon nanotubes, thereby forming a second electrode;
disposing an electrolyte on a first one of the nanowire layers; and
contacting a second one of the nanowire layers with the electrolyte to adhere the first electrode to the second electrode, thereby forming an electrochemical capacitor between the first flexible substrate and the second flexible substrate.

2. The method of claim 1, wherein contacting the second one of the nanowire layers with the electrolyte to adhere the first electrode to the second electrode comprises aligning the selected portions of the first flexible substrate and the selected portions of the second flexible substrate, thereby forming a multiplicity of electrochemical capacitors between the first flexible substrate and the second flexible substrate.

3. The method of claim 1, wherein the first composition and the second composition are different.

4. The method of claim 1, wherein the first nanowires and the second nanowires are different.

5. The method of claim 1, wherein disposing the first nanowires on the first layer of single-walled carbon nanotubes comprises disposing metal oxide nanowires on the first layer of single-walled carbon nanotubes.

6. The method of claim 5, wherein disposing the first nanowires on the first layer of single-walled carbon nanotubes comprises disposing ruthenium oxide nanowires on the first layer of single-walled carbon nanotubes.

7. The method of claim 1, wherein disposing the second nanowires on the second layer of single-walled carbon nanotubes comprises disposing metal oxide nanowires on the second layer of single-walled carbon nanotubes.

8. The method of claim 7, wherein disposing the second nanowires on the second layer of single-walled carbon nanotubes comprises disposing ruthenium oxide nanowires on the second layer of single-walled carbon nanotubes.

9. The method of claim 1, wherein disposing the electrolyte on the first one of the nanowire layers comprises disposing a dry polymer thin film electrolyte on the first one of the nanowire layers.

10. An electrochemical capacitor comprising:
a first electrode comprising:
a first flexible substrate;
a first layer of single-walled carbon nanotubes inkjetted on the first flexible substrate;
a layer of first nanowires disposed on the first layer of single-walled carbon nanotubes;
a second electrode comprising:
a second flexible substrate;
a second layer of single-walled carbon nanotubes inkjetted on the second flexible substrate;
a layer of second nanowires disposed on the second layer of single-walled carbon nanotubes; and
an electrolyte sandwiched between the layer of first nanowires and the layer of second nanowires.

11. The electrochemical capacitor of claim 10, wherein the first nanowires comprise metal oxide nanowires.

12. The electrochemical capacitor of claim 11, wherein the first nanowires comprise ruthenium oxide nanowires.

13. The electrochemical capacitor of claim 10, wherein the second nanowires comprise metal oxide nanowires.

14. The electrochemical capacitor of claim 13, wherein the second nanowires comprise ruthenium oxide nanowires.

15. The electrochemical capacitor of claim 10, wherein the electrolyte is a dry polymer thin film electrolyte.

16. The electrochemical capacitor of claim 15 wherein the electrolyte inhibits transfer of electrons between the first electrode and the second electrode.

17. The electrochemical capacitor of claim 10, wherein the first flexible substrate and the second flexible substrate comprise fabric.

18. An flexible energy storage device comprising
a first flexible substrate;
a second flexible substrate; and
one or more electrochemical capacitors formed between the first flexible substrate and the second flexible substrate.

19. The flexible energy storage device of claim 18, wherein at least one of the electrochemical capacitors comprises:
a first electrode comprising:
a first layer of single-walled carbon nanotubes inkjetted on the first flexible substrate;
a layer of first nanowires disposed on the first layer of single-walled carbon nanotubes;
a second electrode comprising:
a second flexible substrate;
a second layer of single-walled carbon nanotubes inkjetted on the second flexible substrate;
a layer of second nanowires disposed on the second layer of single-walled carbon nanotubes; and
an electrolyte sandwiched between the layer of first nanowires and the layer of second nanowires.

20. The flexible energy storage device of claim 18, further comprising a light-emitting device electrically connected to at least one of the electrochemical capacitors.

21. The flexible energy storage device of claim 18, wherein the first flexible substrate and the second flexible substrate comprise fabric, and flexible energy storage device is an article of clothing.
